(19) United States
(12) Patent Application Publication
(10) Pub. No.: US 2021/0066779 A1
(43) Pub. Date: Mar. 4, 2021

(54) ANTENNA MOUNTING ASSEMBLY

(71) Applicant: CommScope Technologies LLC, Hickory, NC (US)

(72) Inventor: Shital Sawant Udagave, Maharashtra (IN)

(21) Appl. No.: 16/992,191

(22) Filed: Aug. 13, 2020

(30) Foreign Application Priority Data
Aug. 29, 2019 (IN) 201911034841

(51) Int. Cl. H01Q 1/12

(52) U.S. Cl. CPC H01Q 1/1228

(57) ABSTRACT

An antenna mounting assembly includes: a clamping unit configured to clamp to a pole, the clamping unit comprising first and second clamps, the second clamp having first and second ends; a pair of flanges fixedly mounted to the second clamp; a proximal link pivotally attached to the flanges at locations between the first and second ends of the second clamp, the proximal link pivotable about a first axis; a distal link pivotally attached to the flanges about a second axis; and a mounting bracket pivotally attached to the distal link about a third axis, the mounting bracket configured for attachment to an antenna.

### RELATED APPLICATIONS

The present application claims priority from and the benefit of Indian Patent Application No. 201911034841, filed Aug. 29, 2019, the disclosure of which is hereby incorporated herein by reference in its entirety.

### FIELD OF THE INVENTION

The present invention is directed to an antenna mount for base station antennas and methods of using the same.

### BACKGROUND OF THE INVENTION

Base station antennas for wireless communication systems transmit RF signals over long distances. A base station antenna has a characteristic radiation pattern that defines the optimum direction for transmitting/receiving signals. Based on network coverage requirements, cellular operators may find it advantageous to adjust the vertical elevation angle (i.e., the vertical angle of the antenna with respect to the horizon) or “tilt” of the main beam of the radiation pattern of a linear array in order to change the coverage area of the antenna. Such adjustment is typically referred to as “downtilting” as the antenna beam is typically tilted to point at an elevation angle of 0 degrees or less with respect to the horizon such as, for example, an elevation angle of 0 degrees to −10 degrees.

Typically base station antennas are mounted to a pole or the like via two clamp assemblies and a simple pivoting “four-bar linkage” mechanism. These are shown in FIGS. 1 and 2, wherein an antenna 20 is mounted to the pole 30 via two clamp assemblies 40 and a mechanism 50 comprising proximal and distal members 52, 54. The antenna 20 is pivotally attached via a single pivot to the lower clamp assembly 40, which is in turn clamped to the pole 30. The upper clamp assembly 40 is mounted to the pole 30 and is pivotally attached to the proximal member 52. The distal member 54 is fixed to the antenna 20 and pivotally attached to the proximal member 52. The angle between the proximal and distal members 52, 54 can be adjusted to adjust the degree of downtilt of the antenna 20.

It may be desirable to provide other configurations for mounting antennas.

### BRIEF DESCRIPTION OF THE FIGURES

FIG. 1 is a side view of an antenna mounted to a pole according to the prior art.

FIG. 2 is a top perspective view of a mounting assembly employed in FIG. 1.

FIG. 3 is a top perspective view of an antenna mounting assembly according to embodiments of the invention.

FIG. 4 is a top perspective view of the antenna mounting assembly of FIG. 3 with the mounting plate used to attach the assembly to the antenna in place.

FIGS. 5A and 5B are perspective views of the clamps of the antenna mounting assembly of FIG. 3.

FIG. 6 is a perspective view of a flange of the antenna mounting assembly of FIG. 3.

FIG. 7 is a perspective view of a proximal link of the antenna mounting assembly of FIG. 3.

FIG. 8 is a perspective view of a distal link of the antenna mounting assembly of FIG. 3.

FIG. 9 is a perspective view of the mounting plate shown in FIG. 4.

FIG. 10 is an enlarged partial perspective of the clamping unit and upper end of the proximal link of the mounting assembly of FIG. 3.

FIG. 11 is an enlarged partial perspective view of one end of the clamp of FIG. 5A.

FIG. 12 is a perspective view of a nut used in the clamping unit of FIG. 3.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the figures, certain layers, components or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

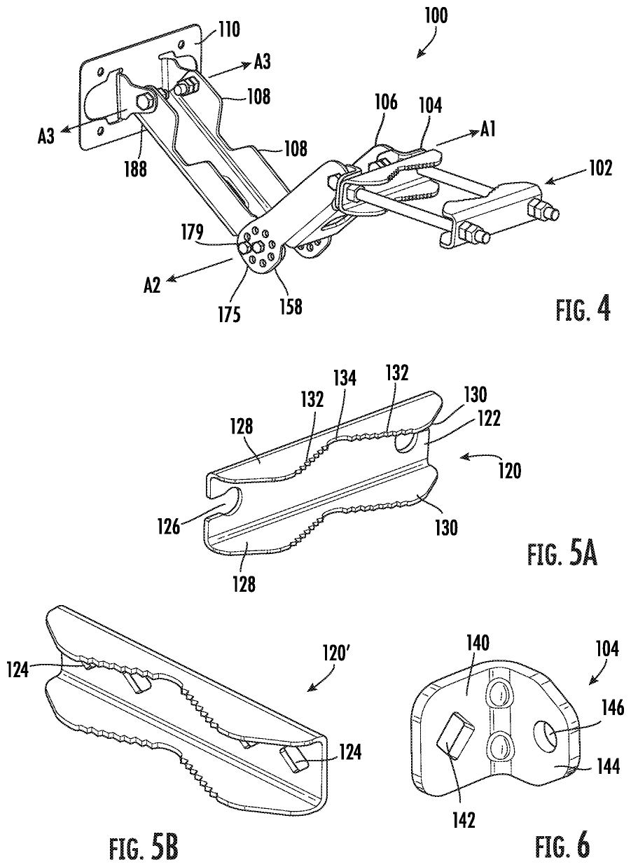

Referring now to the figures, a mounting assembly for an antenna, designated broadly at 100, is shown in FIGS. 3 and 4. The mounting assembly 100 includes a clamping unit 102, two flanges 104, a proximal link 106, a distal link 108, and an antenna mounting plate 110. These components are described in greater detail below.

Referring to FIG. 5A, a clamp 120 includes a main panel 122 with a hole 124 near one side edge and a slot 126 that is open to the opposite side edge. Clamping panels 128 extend from the upper and lower edges of the main panel 122. The clamping panels 128 have clamping edges 130 with teeth 132, wherein the portions of the clamping edges 128 where the teeth 132 are located are relatively straight and inclined toward each other to form a pocket in which a mounting pole can reside. A rounded area 134 is located between the sections of teeth 132 to provide stress relief.

A clamp 120′ (FIG. 5B) is similar in configuration to the clamp 120, but includes a second hole 124 rather than the slot 126, with the holes 124 being square rather than round.

Referring now to FIG. 6, one of the flanges 104 is shown therein. The flange 104 has a mounting panel 140 with a hole 142 therein, and an ear 144 with a hole 146 therein.

As can be seen in FIGS. 10 and 11, the clamping unit 102 includes the clamps 120, 120′ as they are oriented facing each other, with their teeth 132 extending toward the other clamp 120, 120′. A threaded rod 136 is inserted into the hole 124 in each clamp 120, 120′ and secured with a nut 137. A threaded rod 138 is also inserted into the hole 124 in the clamp 120′ and the slot 126 in the clamp 120 and secured with a nut 139 (see FIG. 12). FIG. 10 also shows that the flanges 104 are mounted to the clamp 120′ via the threaded rods 136, 138, which are inserted through the holes 142 in the flanges 104.

Referring now to FIG. 7, the proximal link 106 is shown therein. The proximal link 106 includes a main body 150 with two arms 152 extending perpendicularly from side edges thereof. A hole 154 is located at one end of each arm 152. At the opposite end of each arm 152, a series of holes 158 encircles a hole 156.

As can be seen in FIG. 10, the proximal link 106 is mounted to the flanges 104 via bolts 160 and nuts 162. The bolts 160 define an axis A1 about which the proximal link 106 can pivot relative to the flanges 104 and clamping unit 102.

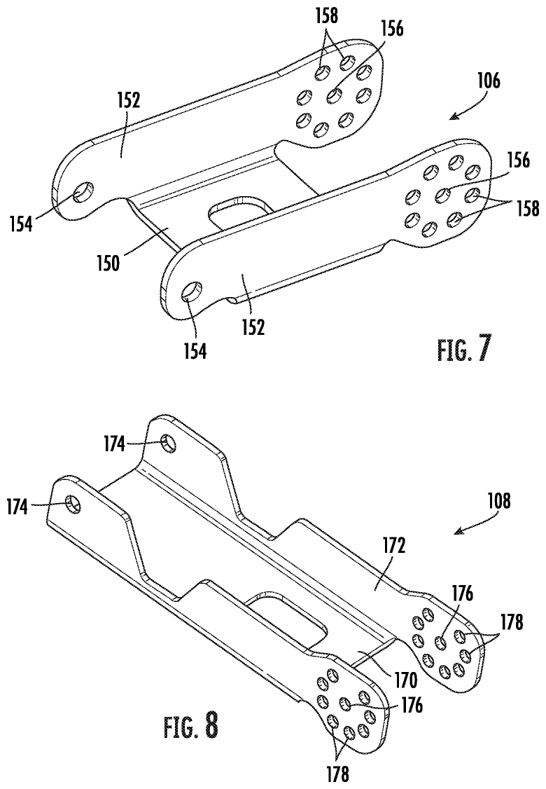

Referring now to FIG. 8, the distal link 108 is shown therein. The distal link 108 includes a main body 170 with two arms 172 extending perpendicularly from side edges thereof. A hole 174 is located at one end of each arm 152. At the opposite end of each arm 172, a series of holes 178 encircles a hole 176.

As can be seen in FIG. 4, the distal link 108 is mounted to the proximal link 106 via bolts 175 inserted through the holes 156, 176. The bolts 175 define an axis A2 about which the distal link 108 can pivot relative to the proximal link 106. The distal link 108 can be maintained at a desired angle relative to the proximal link 106 via pins inserted into one of the holes 158 in the proximal link 106 and one of the holes 178 in the distal link 108. The presence of multiple holes 158, 178 provides multiple possible relative orientations of the proximal and distal links 106, 108.

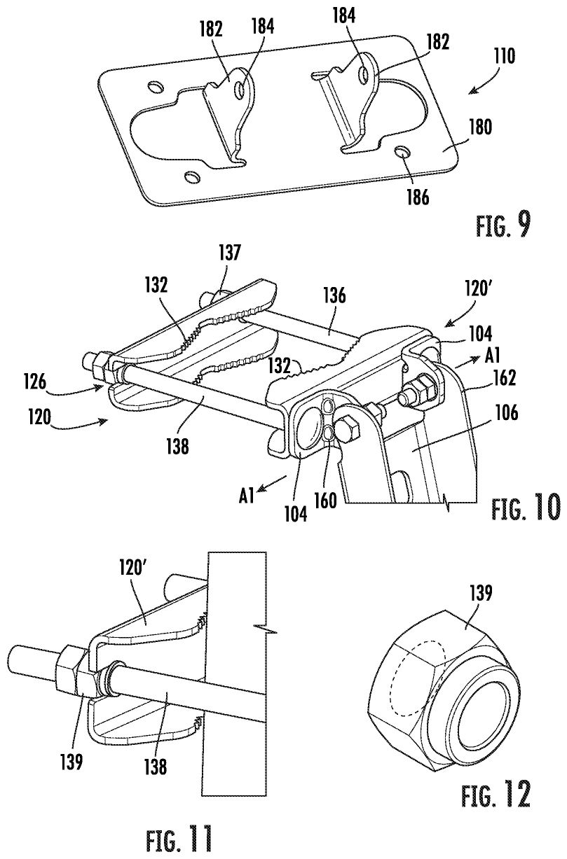

Referring now to FIG. 9, the mounting plate 110 has a main body 180. Two flanges 182 extend perpendicularly from the main body 180 and include holes 184. Four holes 186 are also present in the main body 180 to allow the mounting of an antenna.

Referring to FIG. 4, it can be seen that the mounting plate 110 can be attached to the distal link 108 via bolts 188 inserted through holes 174 in the arms 172 of the distal link 108 and through the holes 184 in the mounting plate 110. The mounting plate 110 is thus able to pivot relative to the distal link 108 about an axis A3 defined by the bolts 188.

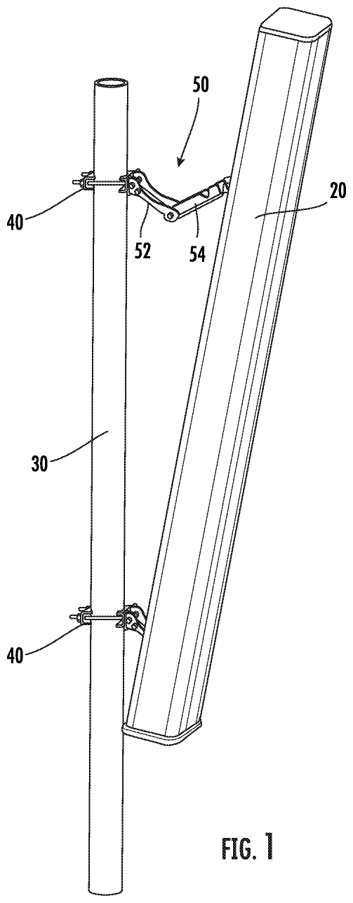

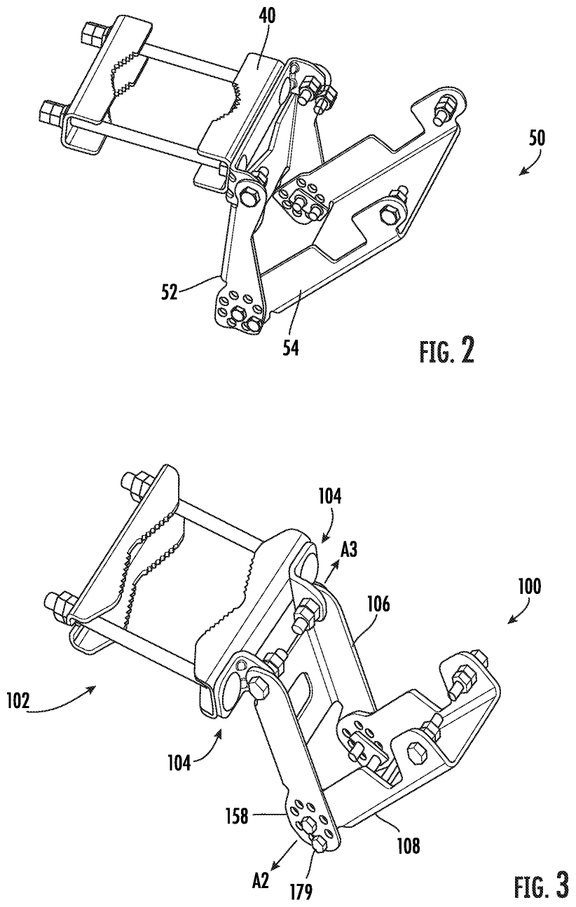

The mounting assembly 100 is mounted to a pole via the clamping unit 102 and to the upper portion of an antenna via the mounting plate 110. The lower portion of the antenna is typically mounted to the pole via a single pivot as described above and shown in FIG. 1. The mounting assembly 100 enables the downtilt on the antenna to be selected by adjusting the relative positions of the proximal and distal links 106, 108 and fixing them in that orientation; this movement is permitted because the proximal and distal links 106, 108 are able to pivot about the axes A1, A3.

The configuration described above can provide advantages over prior antenna mounts. The shape and angle of the teeth 132 on the clamps 120. 120′ can provide improved grip, while the rounded area 134 can reduce stress concentration at a potentially high stress location. The presence of the slot 126 on the clamp 120 can facilitate the mounting of the clamping unit 102 on a pole, as the threaded rod 138 can simply be slipped into the slot 126 from the side.

Also, the use of the flanges 104 to mount the proximal member 106 provides mounting locations inward from the side edges of the clamp 120′. Previously, units employed a single bar mounted to the clamp with fingers extending from the ends of the bar; the bar extended beyond the side edges of the clamp. The flanges 104 enable the use of less material (thereby reducing cost) and also permit the mounting locations for the proximal link 106 to be much closer together, thereby enabling a narrower proximal link 106 to be employed.

The use of a narrower proximal link 106 than employed in prior units allows less material to be employed in the component, thereby reducing cost. Similarly, the distal link 108 is also narrower than prior links, which also reduces material usage and, consequently, cost.

The mounting plate 110 is configured to provide mounting locations for the narrower distal link 108. Because the flanges 182 can be formed by stamping from interior sections of a single metallic sheet, less material can be employed, thereby reducing costs.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. An antenna mounting assembly, comprising:
a clamping unit configured to clamp to a pole, the clamping unit comprising first and second clamps, the second clamp having first and second ends;
a pair of flanges fixedly mounted to the second clamp;
a proximal link pivotally attached to the flanges at locations between the first and second ends of the second clamp, the proximal link pivotable about a first axis;
a distal link pivotally attached to the flanges about a second axis; and
a mounting bracket pivotally attached to the distal link about a third axis, the mounting bracket configured for attachment to an antenna.

2. The antenna mounting assembly defined in claim 1, wherein the proximal link comprises a first plurality of holes encircling the second axis, and wherein the distal link comprises a second plurality of holes encircling the second axis, wherein a pin inserted through one of the first plurality of holes and one of the second plurality of holes establishes an angle between the proximal and distal links.

3. The antenna mounting assembly defined in claim 1, wherein the mounting bracket comprises a main body and a pair of second flanges, and wherein the main panel and ears are formed as a monolithic member.

4. The antenna mounting assembly defined in claim 3, wherein the third axis passes through the second flanges.

5. The antenna mounting assembly defined in claim 1, wherein the second clamp comprises a clamping edge with a plurality of teeth, the teeth divided into distinct and separate first and second sections.

6. The antenna mounting assembly defined in claim 5, wherein a rounded area is located on the clamping edge between the first and second sections of teeth.

7. The antenna mounting assembly defined in claim 1, wherein the distal link includes a main body and a pair of arms disposed generally perpendicularly thereto, wherein the proximal link includes a main body and a pair of arms disposed generally perpendicularly thereto, and wherein the arms of the distal link are substantially parallel with the arms of the proximal link.

8. The antenna mounting assembly defined in claim 1, wherein the clamping unit further comprises first and second rods that extend between the first and second clamps.

9. The antenna mounting assembly defined in claim 8, wherein the first clamp includes a hole that receives the first rod and a slot that receives the second rod.

10. The antenna mounting assembly defined in claim 1, further comprising an antenna mounted to the mounting bracket.

11. The antenna mounting assembly defined in claim 10, further comprising a pole, and wherein the clamping unit is clamped to the pole and the antenna is mounted to the pole at a single pivot.

12. An antenna mounting assembly, comprising:
a clamping unit configured to clamp to a pole, the clamping unit comprising first and second clamps;
a pair of flanges fixedly mounted to the second clamp;
a proximal link pivotally attached to the flanges and pivotable about a first axis;
a distal link pivotally attached to the flanges about a second axis; and
a mounting bracket having a main body and a pair of flanges extending from an internal section of the main body, the flanges pivotally attached to the distal link about a third axis that passes through the pair of flanges of the mounting bracket, the mounting bracket configured for attachment to an antenna.

13. The antenna mounting assembly defined in claim 12, wherein the proximal link comprises a first plurality of holes encircling the second axis, and wherein the distal link comprises a second plurality of holes encircling the second axis, wherein a pin inserted through one of the first plurality of holes and one of the second plurality of holes establishes an angle between the proximal and distal links.

14. The antenna mounting assembly defined in claim 12, wherein the second clamp comprises a clamping edge with a plurality of teeth, the teeth divided into distinct and separate first and second sections.

15. The antenna mounting assembly defined in claim 14, wherein a rounded area is located on the clamping edge between the first and second sections of teeth.

16. The antenna mounting assembly defined in claim 12, wherein the distal link includes a main body and a pair of arms disposed generally perpendicularly thereto, wherein the proximal link includes a main body and a pair of arms disposed generally perpendicularly thereto, and wherein the arms of the distal link are substantially parallel with the arms of the proximal link.

17. The antenna mounting assembly defined in claim 12, wherein the clamping unit further comprises first and second rods that extend between the first and second clamps.

18. The antenna mounting assembly defined in claim 17, wherein the first clamp includes a hole that receives the first rod and a slot that receives the second rod.

19. The antenna mounting assembly defined in claim 12, further comprising an antenna mounted to the mounting bracket.

20. The antenna mounting assembly defined in claim 19, further comprising a pole, and wherein the clamping unit is clamped to the pole and the antenna is mounted to the pole at a single pivot.
